(19) United States
(12) Patent Application Publication
(10) Pub. No.: US 2002/0100767 A1
(43) Pub. Date: Aug. 1, 2002

(54) Liquid container for impeding mouth contact thereon when drinking threfrom

(76) Inventor: Charles B. Mellon, Fresno, CA (US)

Correspondence Address: MARTIN & FERRARO, 14500 AVION PARKWAY, SUITE 300, CHANTILLY, VA, 201511101

(21) Appl. No.: 09/775,108

(22) Filed: Jan. 31, 2001

(51) Int. Cl. B67D 5/58

(52) U.S. Cl. 222/1; 222/465.1; 222/189.07; 222/566; 222/485

(57) ABSTRACT

A liquid holding container is disclosed having one or more spill openings closable by a lid during normal use and adapted to discourage direct user mouth contact with the container when the one or more spill openings are left unexposed by the lid. The liquid holding container may have one or more anti-drink guards projecting away from the container and positioned proximate to the container main flow access for discouraging direct user mouth contact with the main flow access. Also provided is a method for the use of the container.

### BACKGROUND OF THE INVENTION

1. Field of the invention

The present invention relates generally to a container for holding liquid that discourages a user from putting his or her mouth to the container to access the contents thereof, and a method for its use.

2. Description of the related art

The containers of the related art typically include a spout or rim for pouring a liquid contained therein into another container, such as a glass or cup from which a user drinks the liquid. On occasion, some users bypass the second container and put their mouths in direct contact with the container and tip the container towards them to consume the contents directly from the container. This practice is unhealthy, often leading to the potential transmission of diseases from a user's saliva with the contents of the container.

Although this problem has long existed, the containers of the past have presented no satisfactory solution to address this problem. Therefore there exists a need for an improved container for impeding direct contact of a user's mouth with the container to prevent drinking directly therefrom.

### SUMMARY OF THE INVENTION

The present invention is directed to a liquid container such as a pitcher for example that discourages the practice of direct consumption therefrom. In one embodiment, the container is configured to impede drinking directly therefrom by causing the contents of the container to spill on a user when the user attempts to drink directly from the container. When the container is used to pour its contents in a conventional manner, such as to pour its contents into a second container, the container of the present invention preferably functions in a conventional manner and does not spill on the user.

In a preferred embodiment of the invention, a container for holding liquid includes a container body; a cooperatively engageable lid; at least one spill opening located on the container wall that is adapted to be closed by the lid; and a main flow access located in at least one of the container wall and lid, the main flow access being adapted to remain open while the at least one spill opening is closed.

In another preferred embodiment of the invention the container includes a container body; a cooperatively engageable lid with a lid wall and lid wall access for allowing liquid to exit the container when the lid and body are cooperatively engaged; and at least one spill opening located on the container wall that is adapted to be at least partially closed by the lid, the at least one spill opening preferably extending beyond the borders of the lid wall access that intersect the cross section of the lid.

The container of the present invention may further include one or more anti-drink guards projecting away from the container wall and near the main flow access for discouraging a user from consuming the liquid contents directly from the main flow access.

The invention also includes a method for using the container, as will be described in additional detail below.

It is to be understood that both the foregoing general description and the following detailed description are exemplary and explanatory only and are not restrictive of the invention, as claimed. The accompanying drawings, which are incorporated in and constitute a part of this specification, illustrate several embodiments of the invention and together with the description serve to explain the principles of the invention.

### BRIEF DESCRIPTION OF THE DRAWINGS

FIG. 1 is an exploded side elevation view of a container in accordance with a preferred embodiment of the present invention;

FIG. 2 is a top plan view of FIG. 1;

FIG. 3 is a partial front elevation view of FIG. 1;

FIG. 4 is a partial rear elevation view of FIG. 1;

FIG. 5 is a partial side perspective view of the anti-drinking guards of the container of FIG. 1 shown in hidden line;

FIG. 6 is a side perspective view of another preferred embodiment of the present invention;

FIG. 7 is a partial top plan view of FIG. 6;

FIGS. 8a and 8b are side elevation views of other preferred embodiments of lids in accordance with the present invention;

FIGS. 9a and 9b are front perspective views of other preferred embodiments of the container of the present invention;

FIG. 10i a is a partial side elevation view of another preferred embodiment of a container with spill openings of the present invention;

FIG. 10b is a top perspective view of another preferred embodiment of a container with spill openings of the present invention;

FIG. 10c is a partial front view of another preferred embodiment of a container with spill openings of the present invention;

FIG. 11 is a side elevation view of FIG. 6;

FIG. 12 is a side elevation view of an alternative embodiment of FIG. 11;

FIG. 13a is a partial front elevation and exploded view of another preferred embodiment of the present invention;

FIG. 13b is a partial side elevation view of FIG. 13a;

FIG. 14 is a partial front elevation view of another preferred embodiment of the present invention;

FIG. 15 is a side elevation view of another preferred embodiment of the present invention;

FIG. 16 is a front elevation view of FIG. 15;

FIG. 17 is a top plan view of FIG. 15; and

FIG. 18 is side elevation view showing the embodiment of FIG. 15 with a top wall portion shown in partial cross section.

### DETAILED DESCRIPTION OF THE DRAWINGS

Reference will now be made in detail to the present preferred embodiments of the invention, examples of which are illustrated in the accompanying drawings. Similar reference numbers such as 36 and 36a will be used throughout the drawings to refer to similar portions of the same container.

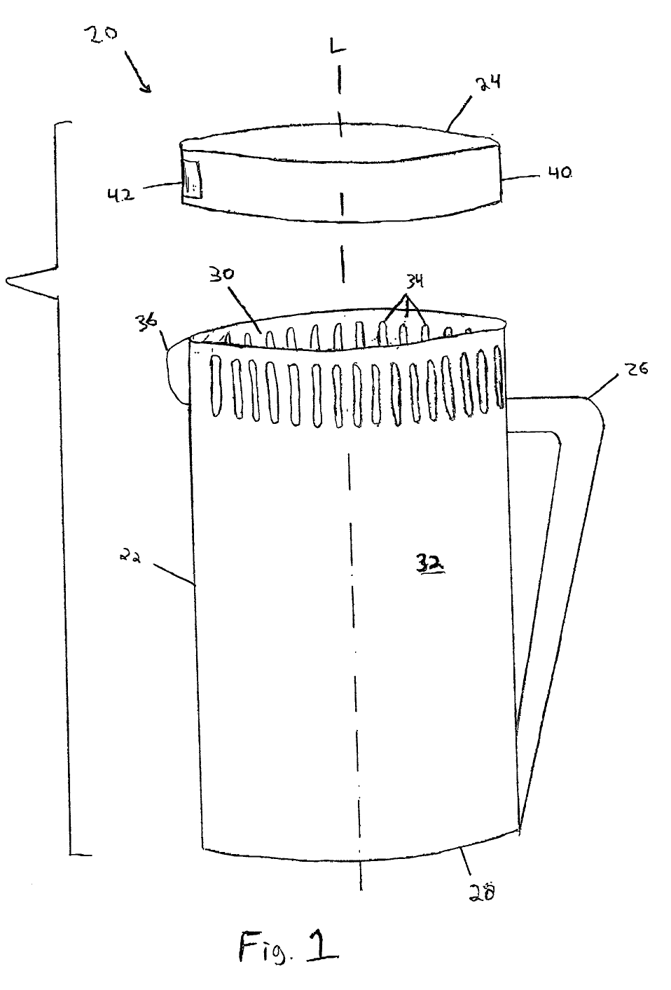

With reference to FIGS. 1-5, a container in accordance with a preferred embodiment of the present invention is indicated generally as 20. Container 20 includes a container body 22, a lid 24, and a handle 26. Container body 22 has a bottom end 28, an open top end 30 opposite bottom end 28, and a wall 32 extending around the longitudinal axis L of the container. Body 22 preferably has a plurality of spaced apart slots 34 arranged circumferentially about longitudinal axis L near open end 30. A spout 38 is located near top end 28 and functions to facilitate pouring contents from the container. A pair of anti-drink guards 36 project away from body 22 proximate to spout 38. The presence of anti-drink guards 36 around spout 38 serve to further discourage user mouth contact with spout 38.

Lid 24 is configured to close top end 28 of container 20 and has a circumferential lid wall 40 extending therefrom. A lid access 42 is present in lid wall 40. Lid 24 is preferably rotatable around axis L. Lid wall 40 is adapted to cover open end 30 of body 22.

With reference to FIG. 1, and with lid 24 optimally engaged with body 22, lid wall 40 closes slots 34 to substantially prevent a liquid from exiting therethrough. At the same time, lid access 42 is aligned with spout 38 to provide a main flow access though which an open flow path is formed, allowing liquid contents to be controllably poured from container 20.

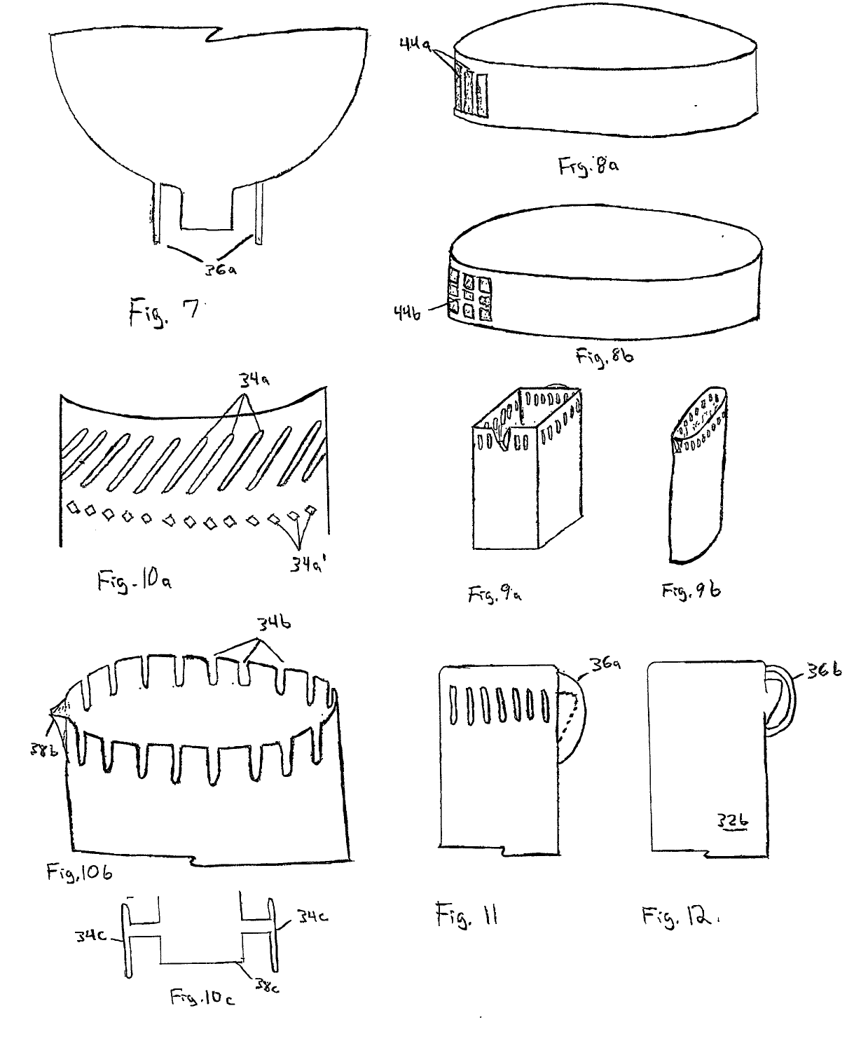

The presence of anti-drink guards 36 around spout 38 serve to further discourage user mouth contact with spout 38. Although illustrated in FIGS. 1-5 as being sloped towards spout 38, guards 36 may project at any angle with respect to body 22. For example, as shown in FIGS. 6 and 7, a pair of anti-drink guards 36a project substantially parallel to the plane formed between axis L and spout 38a.

Referring again to FIGS. 1-5, removing lid 24 from body 22 will expose slots 34, increasing the likelihood of spillage should a user attempt to drink directly form the container. Replacement of lid 24 in body 22 will again close slots 34. Aligning lid access 42 with spout 38 will re-establish a flow path for controllably pouring the liquid contents.

As shown in FIG. 1, lid 24 preferably includes a projecting, circumferential lid wall 40. Lid 24 preferably slides into cooperative engagement with body 22. Alternatively, lid 24 may slide over container wall 32. By way of example only, lid 24 may also cooperatively engage body 22 by means of a screw thread, hinge or other means readily appreciated by those skilled in the art. Further, lid 24 may cooperatively engage body 22 in fixed engagement or freely rotatable engagement. Lid 24 also preferably includes a lid access 42 which, when aligned with spout 38, forms a main flow access through which a flow path is established. Lid access 42 is preferably a notch as shown in FIG. 1. Alternatively, lid access 42 may also include flow dividers for creating multiple flow paths within the main flow access. With reference to FIGS. 8a and 8b, such flow dividers may, by way of example only, be formed as one or more bars 44a or a grid 44b.

Although the preferred embodiment utilizes a main flow access formed through both lid 24 and body 22, the main flow access may also alternatively be formed in body 22 only as illustrated, for example, by a spigot in a water cooler, or in lid 24 only as illustrated by the lid of a water bottle. Further, when opening 38 in body 22 cooperates with lid access 42 to create the main flow access, the main flow access is preferably a spout. Alternatively, opening 38 may also be, for example, a nozzle, open channel, or any opening capable of conveying liquid.

Referring to FIG. 1, body 22 is preferably shaped as a cylinder. Alternatively, as those skilled in the art will appreciate, body 22 may be configured in a variety of ways. For example, referring to FIGS. 9a and 9b, the body may also be square-shaped or oval-shaped. Those skilled in the art will appreciate that although a handle is preferred, such is not necessary in order for the invention to function.

Body 22 preferably includes at least one spill opening, more preferably a plurality of spill openings 34 near open end 30. The openings are sized and shaped to allow liquid to spill out of the container and may be of curved configuration. By way of example only, and with reference to FIG. 10a, such spill openings may be configured as slanted parallel slots 34a, or diamond-shaped holes 34a′. The spill openings need not even be holes in wall 32, but may alternatively include open-ended slots 34b as shown in Fig. 10b. An additional example configuration may include openings 34c branching off from a main flow access 38c as shown in FIG. 10c.

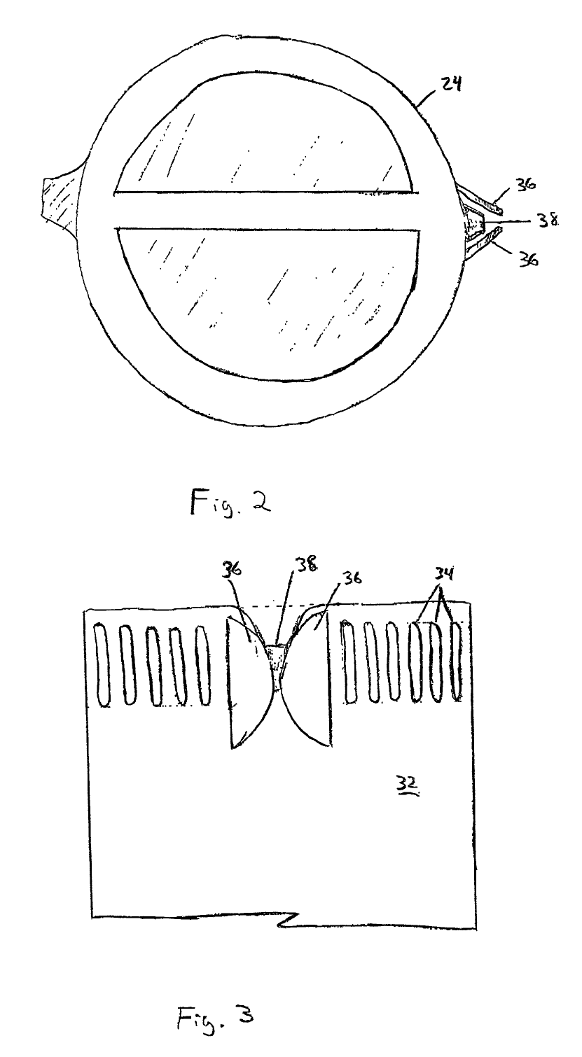

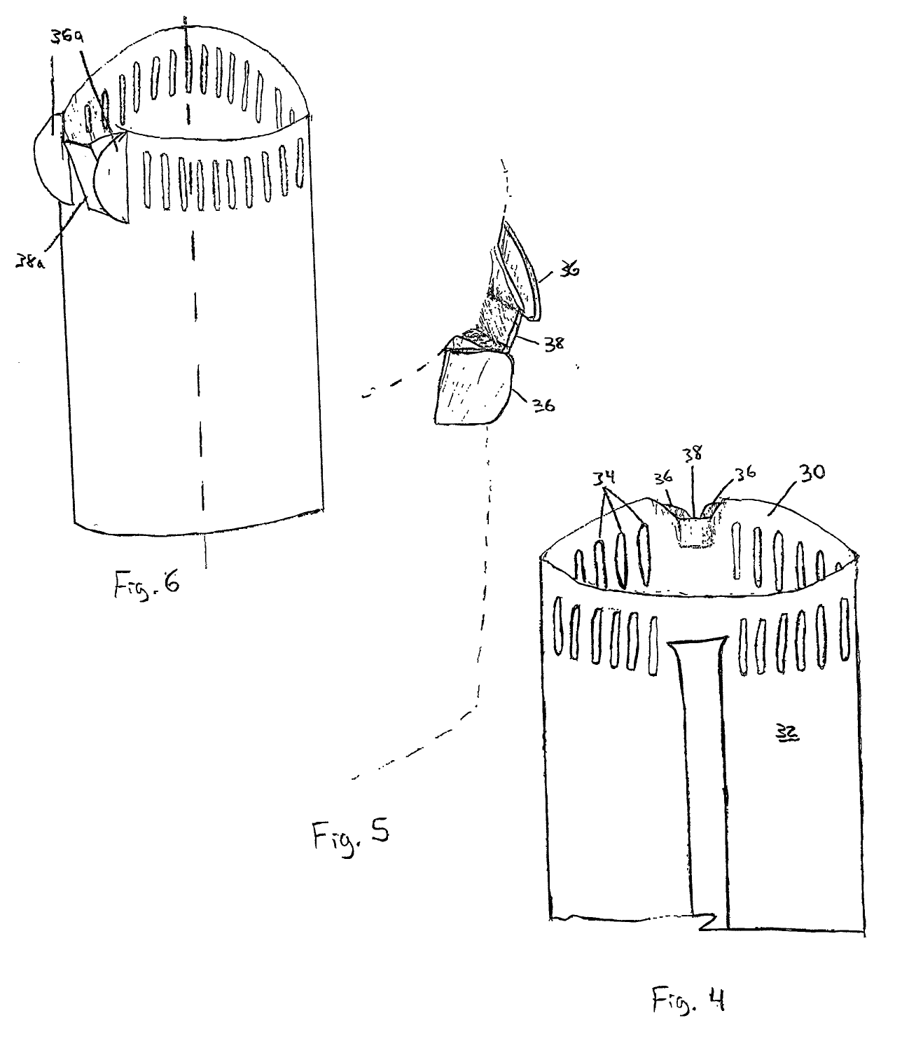

Referring again to FIGS. 1-5, body 22 preferably includes at least one, but more preferably two or more drink guards 36 projecting away from body 22. Anti-drink guards are not required in order to discourage a user from making direct mouth contact with the container. As shown in FIG. 4, for example, the presence of slots 34 located proximate to spout 38 cause liquid to be spilled onto a user if the user attempts to drink from spout 38 without the lid closing slots 34. Nonetheless, the presence of anti-drink guards 36 are beneficial for providing added discouragement of mouth contact with spout 38 when, for example, lid 24 is cooperatively engaged with body 22.

Guards 36 are preferably located proximate to spout 38 and are shaped to make mouth contact with spout 38 difficult. Guards 36 are more preferably shaped as general semicircles as shown in FIGS. 1 and 3. Other variations of height and configuration of the anti-drink guards may be readily appreciated by those skilled art. Guards 36 are preferably sloped towards each other as seen in FIG. 5 so as not to interfere with the flow path of the exiting liquid from spout 38. However, the particular slope of the guards is not critical. For example, and with reference to FIGS. 6 and 7, guards 36a are arranged parallel to the plane formed between the axis L of the container and spout 38a.

Referring to FIGS. 11 and 12, although guards 36 are preferably solid, substantially semicircle-shaped projections, they may also be configured as one or more generally curved bars 36b attached at more than one location to a continuous wall 32b as shown in FIG. 12. Such a configuration is advantageous for reducing material requirements and cost associated therewith.

In accordance with another preferred embodiment of the present invention, and with further reference to FIGS. 13a and 13b, body 22d has a single opening 34d extending substantially around the upper perimeter of wall 32d. Also present are a pair of anti-drink guards 36d preferably positioned generally midway of opening 34d. When lid 24d is in cooperative engagement with body 22d, lid access 42d cooperates with opening 34d to form an exit point for controlled liquid pouring. Unscrewing lid 24d from body 22d by way of a screw thread 46d will expose opening 34d and thus acts to discourage user mouth contact with body 24d for drinking liquid therefrom. Screwing lid 24d back onto body 22d, thereby fixing lid access 42d at a location generally midway of opening 34d and between guards 36d, allows a controlled liquid flow to issue from container 20d. The presence of guards 36d further serve to discourage mouth contact with the container for drinking therefrom.

As shown in FIG. 13d, lid 24d preferably has a screw thread 46d. As will be appreciated by those of skilled art, many means are available for attaching lid 24d to body 22d. Alternatively, lid 24d may be configured similar to the preferred embodiment of FIG. 1, thereby allowing free rotation within body 22d and easy slide engagement between lid 24d and body 22d. Lid 24d also preferably includes lid access 42d, which may be modified in ways already described.

Body 22d preferably includes at least one opening, preferably shaped as a single slot 34d. Alternatively, more than one slot may be used, for example, in a “stacked” relationship, or in a single plane provided at least one of the openings extend beyond the borders of lid access 42d that intersect the cross-section C of lid 24d. It is preferable that the at least one opening extend at least 30 degrees, more preferably 45 degrees, even more preferably 90 degrees, and most preferably 180 degrees around the circumference of body 22d as measured from centerline N.

Referring to FIGS. 13a and 13b, body 22d also preferably includes at least one, more preferably two or more anti-drink guards 36d located preferably proximate to the location where lid access 42d is located while engaged with body 22d. Guards 36d are preferably configured as bars as hereinbefore described.

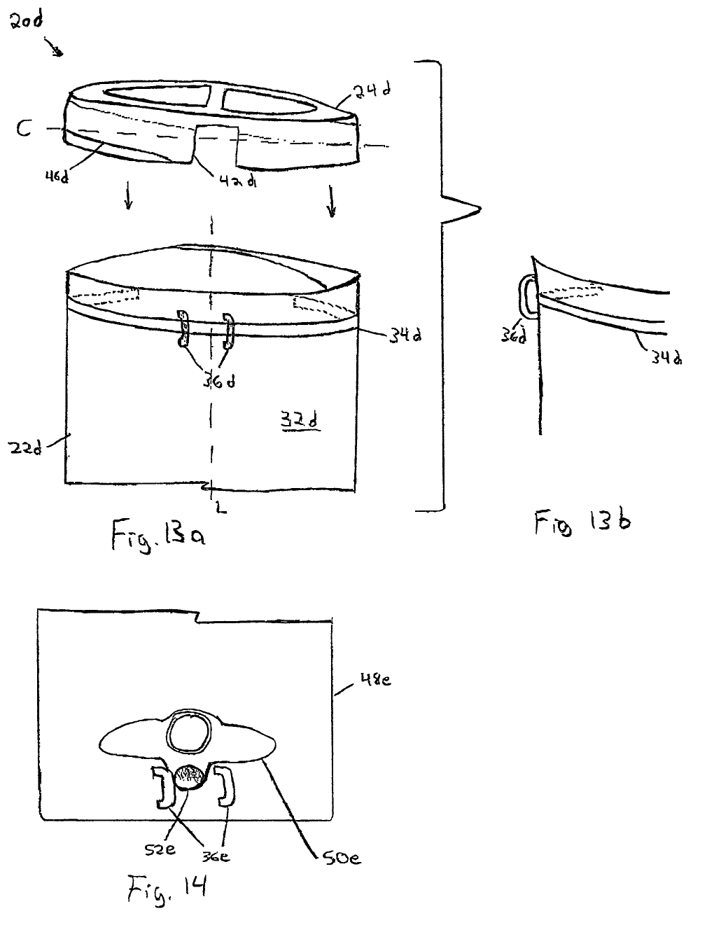

In accordance with another preferred embodiment of the present invention, and with further reference to FIG. 14, a cooler 48e has a spigot 50e and spigot exit 52e. A pair of anti-drink guards 36e on each side of exit 52e discourage user mouth contact with exit 52e. Anti-drink guards 36e are preferably configured as bars as described herein. Those skilled in the art will appreciate that the anti-drink guards may be shaped, sized and positioned in a variety of ways, as discussed herein.

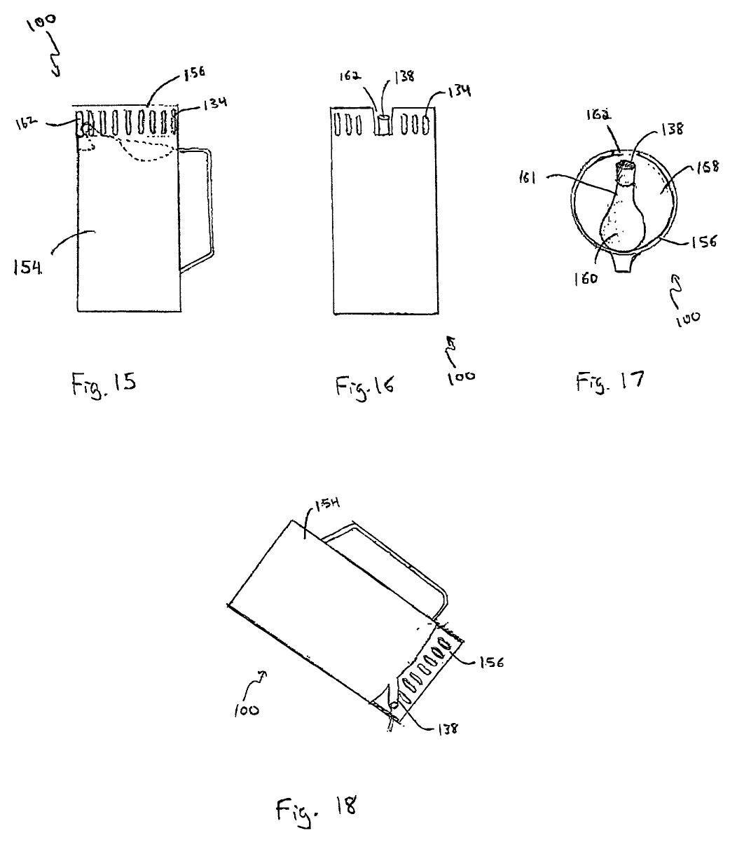

In accordance with another preferred embodiment of the present invention, and with further reference to FIGS. 15-18, container 100 has a lower container wall portion 154, an upper container wall portion 156, and a top surface portion 158, the perimeter of which preferably forms a boundary between the lower and upper container wall portions 154, 156. Although wall portions 154, 156, and top surface 158 are preferably unitary, it is appreciated that each may be separately attached depending upon the method of assembly preferred. Top surface 158 has a spout 138 and a liquid receiving opening 160 for filling container 100 with liquid content. Liquid receiving opening 160 preferably has an elongated slot 161 proximate spout 138 that permits liquid content to exit container 100 more rapidly should the user tip container 100 too far forward. As will be appreciated by those of ordinary skill in the art, opening 160 may be formed in a variety of shapes, need not have a slot 161, and may be separated from spout 138. Upper container portion 156 has a plurality of spaced apart slots 134 arranged circumferentially about its longitudinal axis, and a spout opening 162 preferably diametrically opposite spout 138 for allowing the contents issuing from spout 138 to pass through upper container portion 156 substantially unobstructed. Upper container portion 156 is adapted such that a person using container 100 will be unable to put his or her mouth on spout 138 if attempted.

Container 100 permits liquid content to be poured without the need for a lid. Though a lid is unneeded, it is appreciated that a lid may be adapted for cooperative engagement with top surface 158 and included with the container if so desired.

Having described certain preferred embodiments of the container of the present invention, the method of using this container will now be described in more detail. A method for using a container adapted to hold liquid generally comprises the steps of filling at least a portion of the container with liquid, the container having an open top and a spill opening adapted to permit the passage of liquid therethrough over a greater portion of the perimeter of the container than a user's mouth can cover when the container is tilted to permit pouring of the liquid so as to cause the liquid passing therethrough to spill onto the user; engaging a lid to the container adapted to cover the spill opening; and pouring the liquid from the container via a main flow access in at least one of the container and the lid after the engaging step, the main flow access being adapted to permit the passage of liquid therethrough over a lesser portion of the perimeter of the container than the spill opening.

An alternative method may include the steps of: filling at least a portion of a container with liquid, the container having an open top and a spill opening adapted to permit the passage of liquid therethrough over a greater portion of the perimeter of the container than a user's mouth can cover when the container is tilted to permit pouring of the liquid so as to cause the liquid passing therethrough to spill onto the user; engaging a lid to the container adapted to cover a portion of the spill opening; and pouring the liquid from the container via an uncovered portion of the spill opening to define a main flow access in the container after the engaging step, the main flow access being adapted to permit the passage of liquid therethrough over a lesser portion of the perimeter of the container than the spill opening.

The methods described above may be used in combination with a guard projecting away from at least one of the container and lid and located proximate the main flow access.

Other embodiments of invention will be apparent to those of skill in the art from consideration of the specification and practice of invention disclosed herein. It is intended that the specification and examples may be considered as exemplary only, and that the true scope and spirit of the invention be indicated by the following claims.

What is claimed is:

1. A container for holding liquid, comprising:
a body having a longitudinal axis with a wall extending therearound, a bottom, and an open end opposite said bottom;
a lid cooperatively engaging said body;
at least one spill opening through said wall, said at least one spill opening being adapted to be closed by said lid; and
a main flow access located in at least one of said body and said lid, said access adapted to remain open while said at least one spill opening is closed.

2. The container of claim 1, wherein said at least one spill opening forms at least one slot.

3. The container of claim 2, further comprising a plurality of spaced apart slots along at least a portion of the perimeter of said wall near said open end.

4. The container of claim 1, wherein said lid has a lid wall extending therefrom adapted to close said at least one spill opening when said lid engages said body.

5. The container of claim 1, wherein said main flow access is a spout.

6. The container of claim 1, wherein the cross section of said body perpendicular to said longitudinal axis is one of substantially round and substantially oval.

7. The container of claim 1, further comprising at least one guard projecting away from at least one of said body and said lid and positioned proximate to said main flow access for impeding a user from consuming the liquid contents directly from said main flow access.

8. A container for holding liquid, comprising:
a body having a longitudinal axis with a wall extending therearound, a bottom, and an open end opposite said bottom;
a lid cooperatively engaging said body, said lid having a lid wall extending away from said lid and circumferentially around the longitudinal axis of said lid, said lid wall having a lid wall access for allowing liquid to exit said container when said lid and said body are cooperatively engaged; and
at least one spill opening through said wall of said body, said at least one spill opening being adapted to be at least partially closed by said lid wall.

9. The container of claim 8, wherein said at least one spill opening is sized so that the arc of said at least one spill opening is greater than the arc of said lid wall access.

10. The container of claim 8, wherein the arc of said at least one spill opening is at least 30 degrees.

11. The container of claim 8, wherein said at least one spill opening is a slot.

12. The container of claim 8, further comprising at least one guard projecting away from at least one of said body and said lid and positioned proximate to the location of the lid wall access when said lid is fixed to said body.

13. The container of claim 8, wherein the cross section of said body perpendicular to said longitudinal axis is one of substantially round and substantially oval.

14. A container for holding liquid, comprising:
a body having a longitudinal axis with a wall extending therearound, a bottom, an open end opposite said bottom;
a lid adapted to cooperatively engage said body;
a main flow access located in at least one of said body and said lid; and
at least one guard projecting away from at least one of said body and said lid and positioned proximate to said main flow access for discouraging a user from placing his or her mouth on said main flow access.

15. The container of claim 14, wherein said at least one guard is substantially shaped as one of a semi-circle and a curved bar.

16. The container of claim 14, further comprising at least one spill opening though said wall, said at least one opening being adapted to be closed by said lid, wherein said main flow access is adapted to remain open while said at least one spill opening is closed.

17. The container of claim 14, wherein said main flow access is a spout.

18. The container of claim 14, wherein the cross section of said body perpendicular to said longitudinal is one of substantially round and substantially oval.

19. A method for using a container adapted to hold liquid, the method comprising the steps of:
filling at least a portion of a container with liquid, said container having an open top and a spill opening adapted to permit the passage of liquid therethrough over a greater portion, of the perimeter of said container than a user's mouth can cover when said container is tilted to permit pouring of the liquid so as to cause the liquid passing therethrough to spill onto the user;
engaging a lid to said container adapted to cover said spill opening; and
pouring the liquid from said container via a main flow access in at least one of said container and said lid after the engaging step, said main flow access being adapted to permit the passage of liquid therethrough over a lesser portion of the perimeter of said container than said spill opening.

20. A method for using a container adapted to hold liquid, the method comprising the steps of:
filling at least a portion of a container with liquid, said container having an open top and a spill opening adapted to permit the passage of liquid therethrough over a greater portion of the perimeter of said container than a user's mouth can cover when said container is tilted to permit pouring of the liquid so as to cause the liquid passing therethrough to spill onto the user;
engaging a lid to said container adapted to cover a portion of said spill opening; and
pouring the liquid from said container via an uncovered portion of said spill opening to define a main flow access in said container after the engaging step, said main flow access being adapted to permit the passage of liquid therethrough over a lesser portion of the perimeter of said container than said spill opening.
